(19) United States
(12) Patent Application Publication
(10) Pub. No.: US 2015/0095678 A1
(43) Pub. Date: Apr. 2, 2015

(54) MOVEMENT-BASED STATE MODIFICATION

(71) Applicants: Lama Nachman, Santa Clara, CA (US); Sangita Sharma, Portland, OR (US); Giuseppe Raffa, Portland, OR (US); Adam Jordan, El Cerrito, CA (US); Ashwini Asokan, Sunnyvale, CA (US); Philip Corriveau, Carlton, OR (US)

(72) Inventors: Lama Nachman, Santa Clara, CA (US); Sangita Sharma, Portland, OR (US); Giuseppe Raffa, Portland, OR (US); Adam Jordan, El Cerrito, CA (US); Ashwini Asokan, Sunnyvale, CA (US); Philip Corriveau, Carlton, OR (US)

(21) Appl. No.: 14/040,339

(22) Filed: Sep. 27, 2013

(51) Int. Cl. G06F 1/32

(52) U.S. Cl. CPC G06F 1/3234
USPC 713/323

(57) ABSTRACT

Techniques for modifying a power state of a device are described herein. The techniques include receiving data from a sensor indicating movement of the device, and determining whether the device movement is associated with a predetermined device movement. Based on the determination, the techniques include modifying a power state of the device from either a first power state to a second power state, or from the second power state to the first power state, wherein the device consumes more power in the first power state than in the second power state.

### TECHNICAL FIELD

This disclosure relates generally to techniques for modifying states of a device. More specifically, the disclosure describes techniques for modifying power states of a device including power states of components of a device based on movement of the device.

### BACKGROUND

Computing devices are equipped with an increasing number of sensors configured to detect motion of the device. For example, mobile computing devices, such as smartphones and tablets, may include sensors, such as an accelerometer, a gyroscope, and the like, to detect motion of the device. User interfaces that incorporate gestures of the user may be important differentiating factors in mobile devices.

### BRIEF DESCRIPTION OF DRAWINGS

FIG. 1 is a block diagram of a computing system configured to poll an input/output device.

FIG. 2 is a block diagram illustrating a method for polling an I/O device by a host computing device.

FIG. 3 is a block diagram illustrating a method for modifying a power state of a device.

FIG. 4 is a block diagram depicting an example of a tangible, non-transitory computer-readable medium configured to modify polling rates for an input/output device.

### DETAILED DESCRIPTION

The subject matter disclosed herein relates to techniques for modifying a device power state based on movements of the device. A computing device may include one or more sensors configured to receive data associated with movement of the computing device. The computing device may modify a device, or components of the device, from either a first power state to a second power state, or from the second power state to the first power state, wherein the device consumes more power in the first power state than in the second power state. For example, based on a movement of the device, as indicated by the sensor data, a device may wake up from a sleep state. The embodiments described herein include a system configured to modify a device power state from a low powered state to a high powered state, or from a high powered state to a low powered state. The embodiments described herein include a learning mechanism to reduce false positive power state changes, and a training mechanism to enable a user to train a computing device to recognize a give device movement as a predetermined movement to modify the power state of the device or components of the device.

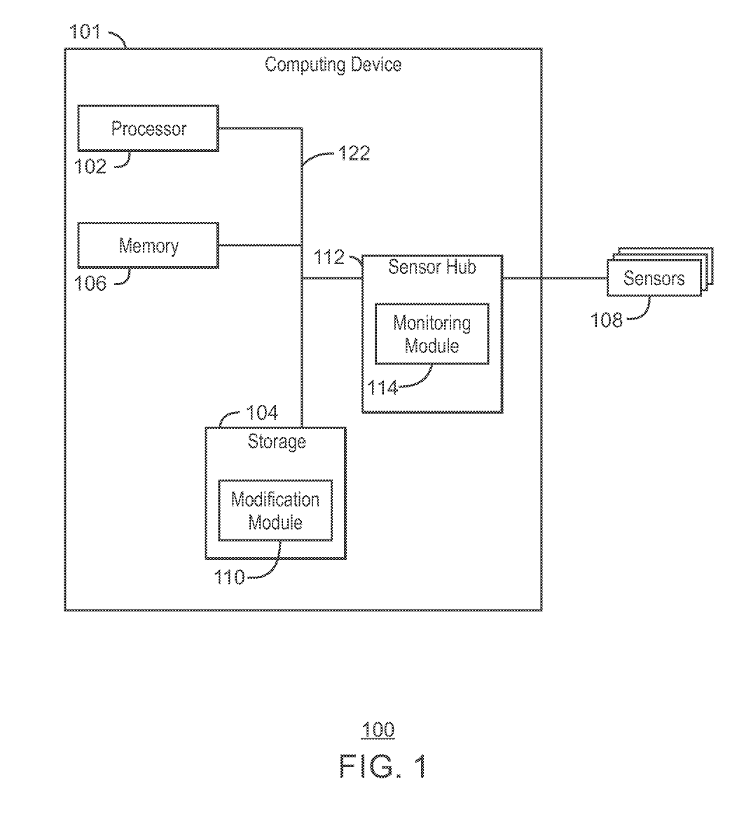

FIG. 1 is a block diagram of a computing system configured to modify a device state based on a movement of the device. The device may be a computing device 101 of the computing system 100. The computing system 100 may include the computing device 101 having a processor 102, a storage unit 104 comprising a non-transitory computer-readable medium, and a memory unit 106. The computing device 101 may be configured to receive input from one or more sensors 108 via sensor logic 112. The one or more sensors 108 may include an accelerometer, a gyroscope, an altimeter, a light sensor, a camera, and the like. Although the sensors 108 in FIG. 1 are illustrated as being remote from the computing device 101, the sensors may either be remote or may be integrated with the computing device 101.

A “power state,” as referred to herein, is a state of a device including a sleep state, a power on state, a power off state, and the like. In embodiments, a power state may refer to an operation of the device wherein a power consumption of the device is changed, such as when a given subsystem of the device is either turned on or off. For example, a subsystem may refer to a graphical user interface display, an audio interface, a wireless interface, and the like. In embodiments, a movement of the device may modify a given subsystem such that the device changes from either a first power state to a second power state or from the second power state to the first power state, wherein the device consumes more power in the first power state than in the second power state.

The sensor logic 112 illustrated in FIG. 1 may be logic within a sensor hub device, in a processor, in other hardware logic, and/or partially implemented in software. The sensor logic 112 may include a monitoring module 114. The monitoring module 114 may be logic, at least partially comprising hardware logic. The monitoring module 114 may receive data from the one or more sensors 108 indicating movement of the computing device 101, and may determine whether the device movement is associated with a predetermined device movement. The logic of the monitoring module 114 may determine whether the device movement is associated with a predetermined device movement based on a threshold. In some cases, the determination of whether the device movement is associated with a predetermined movement may be based on a statistical model. In embodiments, the monitoring module 114 may be implemented as a microcontroller configured to gather data from the sensors 108 indicating whether the device is moving, even while a main processor, such as the processor 102 is inactive. The monitoring module 114 may modify a power state of the computing device, or a power state of a component of the computing device, based on a determination that a given device movement is associated with a predetermined device movement. The power state modification may be from either a first power state to a second power state or from the second power state to the first power state, wherein the device consumes more power in the first power state than in the second power state. In embodiments, the modification from either a first power state to a second power state or from the second power state to the first power state may be implemented by a modification module 110.

The sensor logic 112 may be relatively lower powered microcontroller relative to the processor 102. In embodiments, the sensor logic 112 is active in a relatively low power state when the processor is inactive. The sensor logic 112 may be equipped with movement detection algorithms, such as a lift-motion detection algorithm, on the monitoring module 114. Statistical models or parameters for this algorithm may be set by the device manufacturer and as discussed below.

In some scenarios, a movement of the device may result in a power state modification that is unintended. For example, a user may unintentionally move the computing device 101 such that the monitoring module 114 turns on the device (a “false positive” event). In embodiments, the modification module 110 may be configured to detect false positives, when, for example, a device is turned on in response to a power state modification initiated by a predetermined movement. In embodiments, a statistical model, such as a lift detection model associated with the predetermined movement may be modified by the modification module such that false positive occurrences may be reduced as discussed in more detail below.

In embodiments, the one or more sensors 108 may be smart sensors configured to detect events associated with the predetermined movements. The smart sensors may trigger a power state modification based on whether sensor data indicating device movement reaches a given threshold. In this embodiment, the power state of the computing device 101 or components of the computing device 101 may be modified based on the occurrence of a movement event wherein the sensor data indicating device movement reaches a given threshold.

The processor 102 may be a main processor that is adapted to execute the stored instructions. The processor 102 may be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU).

The memory unit 106 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The main processor 102 may be connected through a system bus 122 (e.g., PCI, ISA, PCI-Express, HyperTransport®, NuBus, etc.) to components including the memory 106, the storage unit 110, and the sensor logic 112.

The block diagram of FIG. 1 is not intended to indicate that the computing device 101 is to include all of the components shown in FIG. 1. Further, the computing device 101 may include any number of additional components not shown in FIG. 1, depending on the details of the specific implementation.

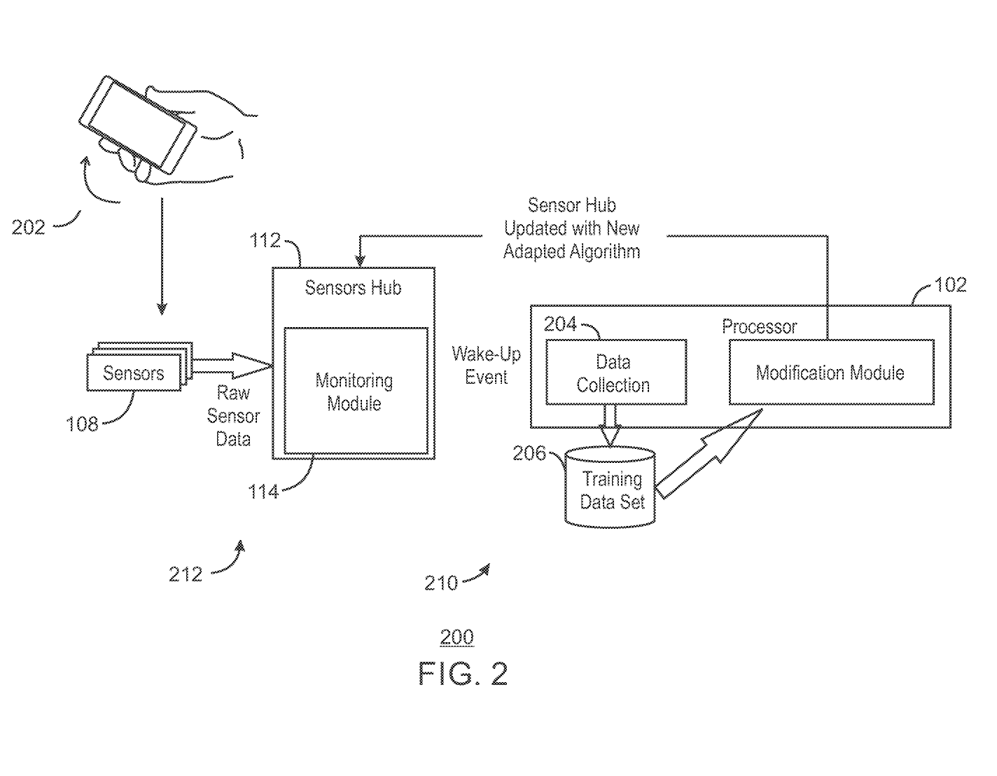

FIG. 2 is a process flow diagram illustrating modification of a device power state based on the movement of the device. A user 202 may initiate a movement of a device, such as the computing device 101 of FIG. 1. The movement may be detected by one or more sensors, such as the one or more sensors 108 of FIG. 1. The sensor logic 112 may receive raw sensor data as indicated in FIG. 2. The monitoring module 114 of the sensor logic 112 is configured to determine whether a modification event has occurred based on the sensor data received. For example, the user 202 may pick up, or lift the computing device 101, in a manner recognized by the monitoring module 114 as being associated with turning on the computing device 101. The monitoring module 114 may provide a signal indicating a wake-up event to a main processor, such as the processor 102 of FIG. 2.

In embodiments, the monitoring module 114 may determine a false positive. A false positive is a detection of a motion by the monitoring module 114 that was not intended by the user to change the device power state. For example, the monitoring module 114 may determine that a movement has occurred and may determine that the movement is similar to a predetermined movement associated with a change of the device power state. As a result, the monitoring module 114 may provide an event, such as the wake-up event illustrated in FIG. 2, to the processor 102 to wake up the device. In response to the device waking up, the user may turn off the device via a power button for example. The user's response may be identified by a user action, such as turning off the device, within a given amount of time for example. As another example, the device may include an automatic power off function after a power state modification. In this scenario, the automatic power off function may identify false positives as a result of the power state modification associated with the predetermined movement. Based on the user's reaction, or lack of reaction, the processor 102 may determine that the motion detected was not intended to wake up the device, and data relating to a false positive motion may be collected at block 204, and provided to a database 206 for updating the gesture detection model.

In embodiments, the user may set the predetermined motion used to modify the power state of the device. For example, rather than relying on a given model set by the manufacturer of the device, the user may train the device to modify a given power state of the device based on a user-defined movement of the device. In embodiments, the device may guide the user on reasonable gesture definition for high accuracy and low false detections. For example, if the user defines a movement that can be confused with a movement associated with other operations of the device, the system may provide the user with alternative movements, or with a measure of effectiveness that provides the user with the option to redefine the movement.

Whether the movement is defined by the user, or by a manufacturer, once the movement has been defined, the system can continually modify and improve movement detection and recognition by collecting and analyzing training data including false positives. In embodiments, power consumption related to false positives is managed by providing a multi-sensor/multi-layer approach to device power state modification. For example, the device detecting a movement determined to be associated with a power state modification will transition the device from a relatively low power state, such as the first power state discussed above, to a medium power state, wherein the medium power state is relatively higher than the first power state, such as a sleep state, and is relatively lower than a high power state, such as the second power state discussed above that may include a powered on or waked state. One such sensor that may be used in this type of embodiment may include a capacitive touch sensor that may detect hover associated with the user holding the device at the screen edges, such as at a bezel of the screen edge. If a hover is detected, it provides additional confirmation of a higher powered wake up of the device. Another such sensor that may be used in this type of embodiment may include an ambient light sensor that determines that the device is tucked away in a moving bag and hence should not be put into a high-power state, or not modified from the medium power state to the high power state.

In embodiments, a false positive may be determined by whether a device reaches a predetermined final position or not. A predetermined final position may be indicated by reduced movement of the device. The predetermined final position may be associated with a position, or angle, typically associated with use of the device. In some scenarios, some devices may incorporate a look verification feature wherein a user must look at a camera of the device in order for the device to verify the user and turn on the device. In embodiments, the predetermined final position includes the position associated with the look verification.

In embodiments, the modification of power states may be associated with specific operations associated with platform-power consumption. For example, a movement of the device may be associated with turning on/off specific subsystems such as a display of the device, an audio interface of the device, a wireless interface, such as a network interface card, and the like.

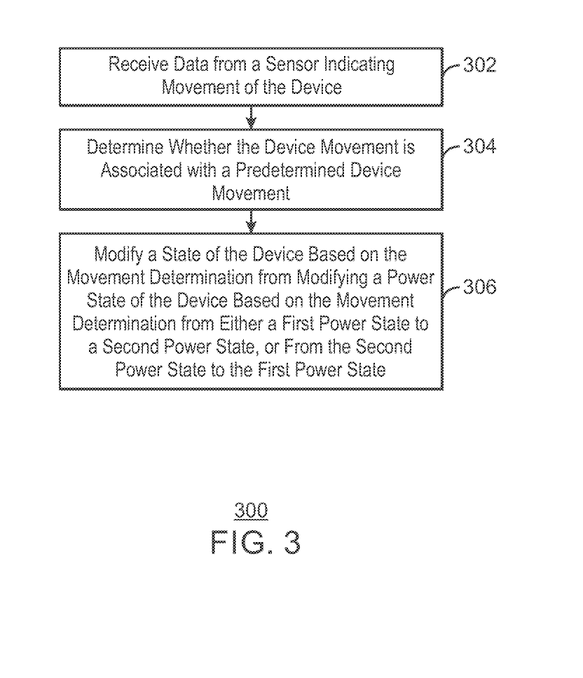

FIG. 3 is a block diagram illustrating a method for modifying a power state of a device. At block 302, data is received from a sensor indicating movement of the device. At block 304, it is determined whether the device movement is associated with a predetermined device movement. At block 306, the power state of the device is modified. The power state may be modified from either a first power state to a second power state or from the second power state to the first power state, wherein the device consumes more power in the first power state than in the second power state.

In embodiments, the method 300 may include determining a false positive power state modification. As discussed above in reference to FIG. 2, the device may detect false positives by modifying the power state and receiving user feedback indicating whether the power state modification was intended by a user of the method 300. Based on the determination of the false positive, a movement module a predetermined device movement is updated. In embodiments, false positives may be reduced by detecting a predetermined final position associated with the predetermined movement. The predetermined final position is a position following a predetermined movement. For example, upon receiving sensor data indicating movement of the device, the device may detect that a predetermined position associated with a user interacting with the device, by holding the device upright for example, has occurred. In some cases, a device may have a look-verification mechanism wherein a camera of the device verifies that the user is looking at the device to modify a device state. In embodiments, the predetermined final position is the position and/or angle at which the device is held during the look-verification mechanism. In embodiments, false positives are reduced by associating the predetermined position with a position during look-verification.

In embodiments, the predetermined movement may be designated by the user. In this embodiment, the device may be trained by the user to recognize a specific movement. The device may also direct the user to change the user designated movement based on a measure of effectiveness indicating a measure of difference from other movements associated with other modifying operations.

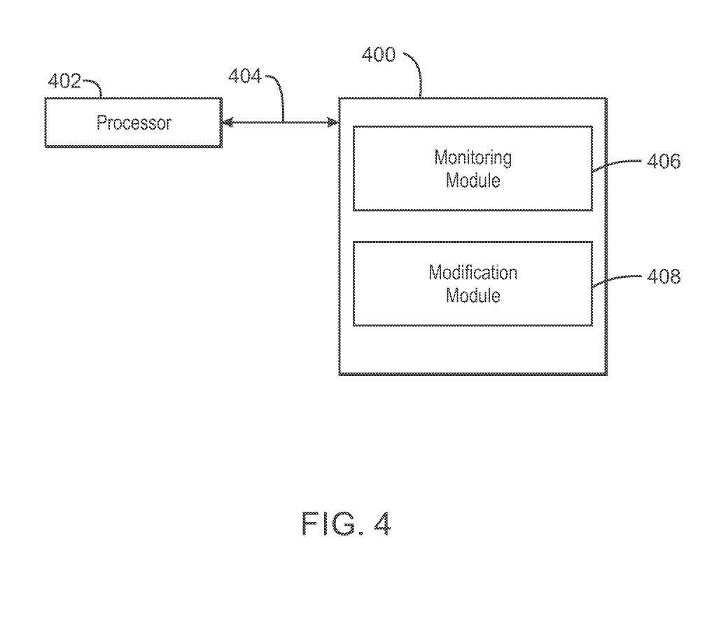

FIG. 4 is a block diagram depicting an example of a tangible, non-transitory computer-readable medium configured to modify polling rates for an input/output device. The tangible, non-transitory, computer-readable medium 400 may be accessed by a processor 402 over a computer bus 404. Furthermore, the tangible, non-transitory, computer-readable medium 400 may include computer-executable instructions to direct the processor 402 to perform the steps of the current method.

The various software components discussed herein may be stored on the tangible, non-transitory, computer-readable medium 400, as indicated in FIG. 4. For example, a monitoring module 406 may be configured to receive data from a sensor indicating movement of the device, and determine whether the device movement is associated with a predetermined device movement. The monitoring module 406 may be configured to modify a power state of the device based on the movement determination from either a first power state to a second power state or from the second power state to the first power state, wherein the device consumes more power in the first power state than in the second power state. A modification module 406 may be configured to update movement models based on false positive determinations, as well as continuous improvement and training of the modification module. Although not indicated in FIG. 4, the monitoring module 406 and the modification module 408 may be disposed on separate tangible, non-transitory computer-readable mediums. Further, the monitoring module 406 and the modification module 408 may be configured to carry out operations on separate processing devices, rather than one processing device 402 as illustrated in FIG. 4.

### EXAMPLE 1

A method for modifying a power state of a device is described herein. The method includes receiving data including events from a sensing means, such as a movement sensor indicating movement of the device. The method includes determining whether the device movement is associated with a predetermined device movement. For example, a predetermined device movement may include a device movement set by the user, or by the designer of the device, for the purposes of turning on the device. The power state of the device may be modified. The modification of a power state of the device is based on the movement determination from either a first power state to a second power state or from the second power state to the first power state, wherein the device consumes more power in the first power state than in the second power state.

### EXAMPLE 2

A system for modifying a power state of a device is described herein. The system includes a sensing means, such as a movement sensor to gather data indicating whether the device is moving. In embodiments, the system may include sensor logic, at least partially including hardware logic, to receive the data from the sensor indicating movement of the device, and to determine whether the device movement is associated with a predetermined device movement. If the movement is associated with the predetermined device movement, the sensor logic may modify a power state of the device based on the movement determination from either a first power state to a second power state or from the second power state to the first power state, wherein the device consumes more power in the first power state than in the second power state.

### EXAMPLE 3

A tangible computer-readable medium is described herein. The tangible computer-readable medium having instructions to direct a processor to carry out operations, the operations including receiving data from a sensing means, such as a movement sensor indicating movement of the device. The operations may include determining whether the device movement is associated with a predetermined device movement, and modifying a power state of the device based on the movement determination from either a first power state to a second power state or from the second power state to the first power state, wherein the device consumes more power in the first power state than in the second power state.

Some embodiments may be implemented in one or a combination of hardware, firmware, and software. Some embodiments may also be implemented as instructions stored on the tangible non-transitory machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus, comprising:
sensor logic, at least partially comprising hardware logic, to carry out operations, the operations comprising:
receiving data including events from a sensor indicating movement of the device;
determining whether the device movement is associated with a predetermined device movement; and
modifying a power state of the device based on the movement determination from either a first power state to a second power state, or from the second power state to the first power state, wherein the device consumes more power in the first power state than in the second power state.

2. The apparatus of claim 1, the operations comprising:
determining a false positive power state modification; and
updating the a movement model associated with the predetermined device movement based on the false positive power state modifications.

3. The apparatus of claim 2, wherein determining a false positive power state modification comprises receiving data from a sensor indicating a predetermined position of the device, the predetermined position associated with a final position of the predetermined device movement, wherein when the final position is reached the power state modification is determined not to be a false positive.

4. The apparatus of claim 1, wherein the predetermined device movement is designated by a user of the device.

5. The apparatus of claim 4, comprising:
a processing device, and
a storage device comprising instructions to direct the processing device to:
receive data from the sensor indicating the predetermined device movement designated by the user; and
train the device to recognize the user-designated movement.

6. The apparatus of claim 5, wherein training the device comprises directing the user to designate a movement that is distinct from movements associated with other modifying operations.

7. The apparatus of claim 5, comprising instructions to direct the processing device to provide the user with a measure of effectiveness indicating a measure of difference from other movements associated with other modifying operations.

8. A method for modifying a power state of a device, the method comprising:
receiving data including events from a sensor indicating movement of the device;
determining whether the device movement is associated with a predetermined device movement; and
modifying a power state of the device based on the movement determination from either a first power state to a second power state, or from the second power state to the first power state, wherein the device consumes more power in the first power state than in the second power state.

9. The method of claim 8, comprising:
determining a false positive power state modification; and
updating the a movement model associated with the predetermined device movement based on the false positive power state modifications.

10. The method of claim 9, wherein determining a false positive power state modification comprises receiving data from a sensor indicating a predetermined position of the device, the predetermined position associated with a final position of the predetermined device movement, wherein when the final position is reached the power state modification is determined not to be a false positive.

11. The method of claim 9, wherein the predetermined device movement is designated by a user of the device.

12. The method of claim 11, comprising:
receiving data from a sensor indicating the predetermined device movement designated by the user; and
training the device to recognize the user-designated movement.

13. The method of claim 12, wherein training the device comprises directing the user to designate a movement that is distinct from movements associated with other modifying operations.

14. The method of claim 12, comprising providing the user with a measure of effectiveness indicating a measure of difference from other movements associated with other modifying operations.

15. The method of claim 8, wherein the data is received at sensor logic comprising a microcontroller configured to determine whether the device movement is associated with a predetermined device movement, and modify the device power state based on the determined movement.

16. A system for modifying a power state of a device, the system comprising:
a sensor to gather data indicating whether the device is moving;
sensor logic, at least partially comprising hardware logic, to:
receive the data from the sensor indicating movement of the device;
determine whether the device movement is associated with a predetermined device movement; and
modify a power state of the device based on the movement determination from either a first power state to a second power state, or from the second power state to the first power state, wherein the device consumes more power in the first power state than in the second power state.

17. The system of claim 16, the sensor logic at least partially comprising hardware logic to:
determine a false positive power state modification; and
update the a movement model associated with the predetermined device movement based on the false positive power state modifications.

18. The system of claim 17, wherein determining a false positive power state modification comprises receiving data from a sensor indicating a predetermined position of the device, the predetermined position associated with a final position of the predetermined device movement, wherein when the final position is reached the power state modification is determined not to be a false positive.

19. The system of claim 16, wherein the predetermined device movement is designated by a user of the device.

20. The system of claim 19, comprising:
a processing device, and
a storage device comprising instructions to direct the processing device to:
receive data from the sensor indicating the predetermined device movement designated by the user; and
train the device to recognize the user-designated movement.

21. The system of claim 20, wherein training the device comprises directing the user to designate a movement that is distinct from movements associated with other modifying operations.

22. The system of claim 16, comprising instructions to direct the processing device to provide the user with a measure of effectiveness indicating a measure of difference from other movements associated with other modifying operations.

23. A tangible computer-readable medium comprising instructions to direct a processor to carry out operations, the operations comprising:
receiving data from a sensor indicating movement of the device;
determining whether the device movement is associated with a predetermined device movement; and
modifying a power state of the device based on the movement determination from either a first power state to a second power state, or from the second power state to the first power state, wherein the device consumes more power in the first power state than in the second power state.
